(19) United States
(12) Patent Application Publication
(10) Pub. No.: US 2023/0259411 A1
(43) Pub. Date: Aug. 17, 2023

(54) MULTIPLE WEB API CALL DEADLOCK PREVENTION

(71) Applicant: International Business Machines Corporation, Armonk, NY (US)

(72) Inventor: Koichiro Maeda, Setagaya-ku (JP)

(21) Appl. No.: 17/672,062

(22) Filed: Feb. 15, 2022

(51) Int. Cl. G06F 9/52; G06F 9/54; H04L 67/02

(52) U.S. Cl. CPC G06F 9/524; G06F 9/547; H04L 67/02

(57) ABSTRACT

An approach for preventing deadlocks when calling a plurality of web services in a single transaction. The approach receives a list of service definitions from a client to call as a single unit of work (UOW). The approach sorts, based on applying a predetermined ordering rule, the list into a standardized order list. The approach sends the standardized order list to the client for execution.

### TECHNICAL FIELD

The present invention relates generally to preventing deadlocks in application programming interface (API) calls, and specifically, to preventing deadlocks in World Wide Web (Web) based API calls.

### BACKGROUND

Considering the current increase in Cloud Native application development, the publication and reuse of Web APIs that utilize light RESTful web services are becoming more prevalent. In such cases, one business use case is achieved by making multiple asynchronous calls to an API, e.g., multiple calls to a Microservices Architecture API.

RESTful web services are basically ideally stateless services. If this principle is applied to all services, then service users will not have concerns about exclusive control of the API to prevent deadlocks. However, in reality there has been a common business requirement that multiple web service calls be processed as one transaction, i.e., Unit of Work (UOW) while ensuring atomicity, consistency, isolation, and durability (ACID) properties.

There are two major approaches to achieve this: optimistic locking and pessimistic locking. Optimistic locking sequentially calls multiple services in a single transaction without explicitly performing exclusive locking, and if it is verified that all the processes have been completed normally without conflicting with other transactions, then the processes are confirmed, otherwise, if any of the processes fail, then all processes will be returned to their original states. Pessimistic locking explicitly acquires a lock and then sequentially and exclusively calls multiple services. If all the processes have completed normally, then the processes are confirmed. If any of the processes fail, then all processes are returned to their original state and the acquired lock is released.

In either approach, when service users call services in any order without consideration of others, if the order differs between programs and differing programs call services for the same group of resources near concurrently, the service users can affect each other within the API, which lowers the success rate of the program calls. In particular, in the case of the latter pessimistic locking, the service calls of different programs may wait for each other's lock to release, resulting in a deadlock.

It is a common perception in the IT industry that occurrence of deadlocks should be suppressed as much as possible as deadlocks cause unfavorable situations for application users and operators, such as reduced availability of the application, waste of system resources, and increased costs for solving the deadlock condition.

### BRIEF SUMMARY

According to an embodiment of the present invention, a computer-implemented method for preventing deadlocks when calling a plurality of web services in a single transaction, the computer-implemented method comprising: receiving, by one or more processors, a list of service definitions from a client to call as one unit of work (UOW); sorting, by the one or more processors, the list into a standardized order list based on operations comprising applying a predetermined sorting rule; and sending, by the one or more processors, the standardized order list to the client for client execution.

According to an embodiment of the present invention, a computer program product for preventing deadlocks when calling a plurality of web services in a single transaction, the computer program product comprising: one or more non-transitory computer readable storage media and program instructions stored on the one or more non-transitory computer readable storage media, the program instructions comprising: program instructions to receive a list of service definitions from a client to call as one unit of work (UOW); program instructions to sort the list into a standardized order list based on operations comprising applying a predetermined sorting rule; and program instructions to send the standardized order list to the client for client execution.

According to an embodiment of the present invention, a computer system for preventing deadlocks when calling a plurality of web services in a single transaction, the computer system comprising: one or more computer processors; one or more non-transitory computer readable storage media; and program instructions stored on the one or more non-transitory computer readable storage media, the program instructions comprising: program instructions to receive a list of service definitions from a client to call as one unit of work (UOW); program instructions to sort the list into a standardized order list based on operations comprising applying a predetermined sorting rule; and program instructions to send the standardized order list to the client for client execution.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments for reducing the likelihood of occurrence of deadlocks based on unifying the orders of exclusion in one unit of work (UOW). Accordingly, performing exclusive processing in a unified order among all programs trying to use a service reduces the likelihood of occurrence of deadlocks.

The embodiments described subsequently provide a “coordinator” that resets the order according to standardized rules upon reception of a list of web services to be called in one transaction so that all the applications that can conflict with each other in exclusion processing can determine the call order through the guidance of the coordinator. Accordingly, all applications using the coordinator can call multiple web services in a unified order, thereby reducing the likelihood of occurrence of a deadlock between any grouping of calls. Further, not only the different web service call orders but also control over the order of calling web services more than once while changing parameters is highly useful. In another aspect, central management of this coordinator provides the capability to respond to, for example, the provision of more detailed rules and instantaneous rule changes, which also contributes to an improvement in processing efficiency.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

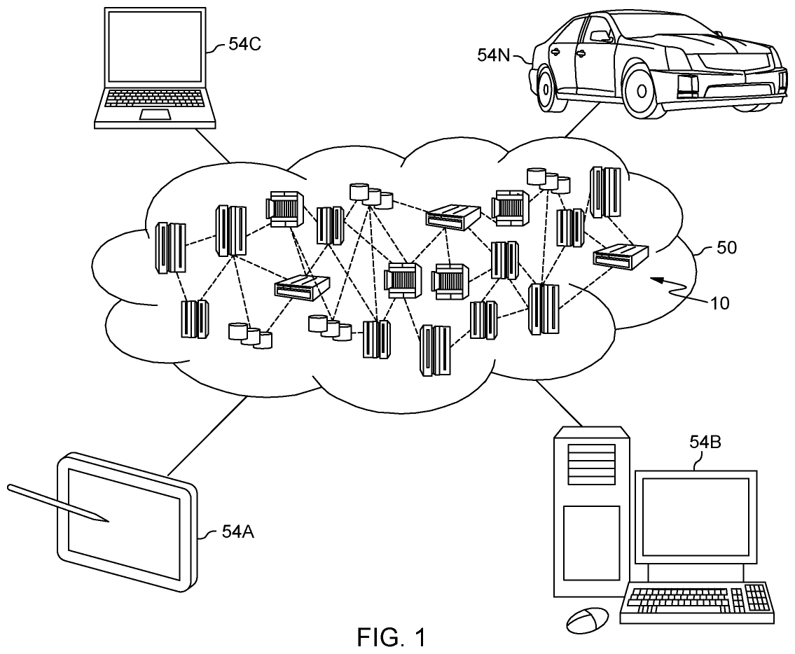

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

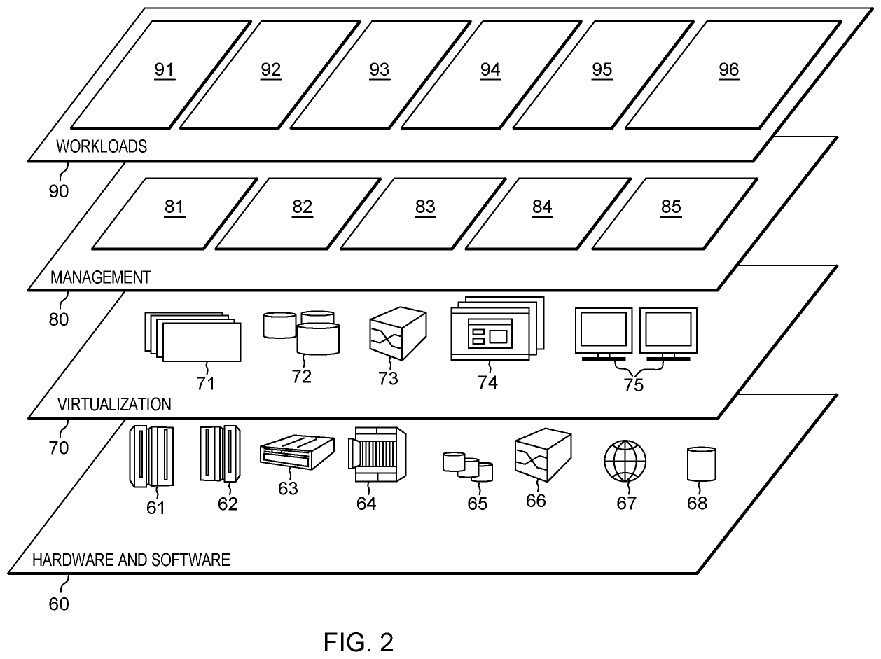

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and deadlock prevention management 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

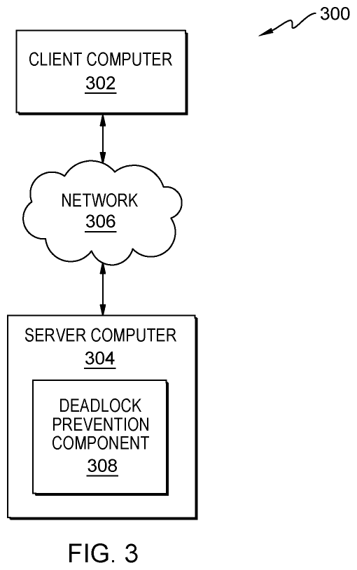

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram, showing a deadlock prevention system, to which the invention principles may be applied. The architecture 300 comprises a client computer 302, a deadlock prevention component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

In one embodiment of the present invention, deadlock prevention component 308, operational on server computer 304, can reduce the likelihood of the occurrence of deadlocks based on unifying the order of exclusion in one unit of work (UOW). Accordingly, if exclusion processing is performed in a unified order among all clients requesting to use a service, the likelihood of the occurrence of deadlocks can be reduced.

In another embodiment of the present invention, deadlock prevention component 308 can determine dynamically an execution order from the external signature, i.e., entry point, upon execution without depending on the internal implementation of the called service. It should be noted that the execution order can be determined relatively easily, e.g., at low computational cost, while the followability to expected changes, e.g., addition of services, changes of signatures, etc. is excellent. Accordingly, the probability of preventing deadlocks can be high.

In another aspect of an embodiment of the present invention, deadlock prevention component 308 can implement order limiting factors such as, but not limited to, business dependencies between services and execution preconditions based on a user's request, allowing the execution order to be determined while satisfying a client's order limiting constraints.

In another aspect of an embodiment of the present invention, deadlock prevention component 308 can provide the capability to allow multiple entry points, e.g., call methods, based on a mechanism for standardizing service names and name identification to absorb fluctuations in entry points, allowing highly effective ordering. Further, for simple conversion of host names and IP addresses, a name identification function utilizing a domain name system (DNS) is provided to allow name identification without setting a predefined rule for name identification.

In another aspect of an embodiment of the present invention, deadlock prevention component 308 can provide the capability to allow the same service to be called two or more times based on determining the execution order according to rules considering the key items, e.g., primary key, search key, etc., of the service to prevent a conflict between processes calling the same service more than once. It should be noted that this is generally caused by crossing between the orders in a row-level lock on the same table.

In another embodiment of the present invention, deadlock prevention component 308 can provide a mechanism that can analyze results of the case where client applications have called a service in the execution order determined by deadlock prevention component 308, e.g., provided to specify call patterns that frequently cause errors and create revisions of the execution order and apply it, thereby improving execution order determination logic and then further enhancing deadlock prevention.

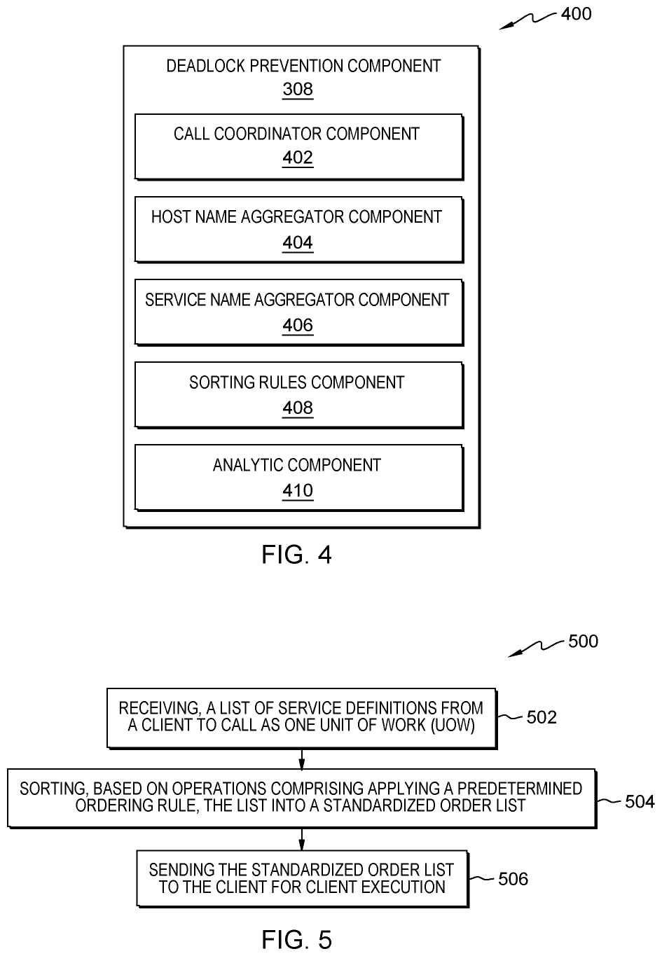

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, more or less elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a deadlock prevention component 308, which can further comprise a call coordinator component 402, a host name aggregator component 404, a service name aggregator component 406, a sorting rules component 408 and an analytic component 410.

A client application that requires calling multiple web services in a single transaction can list and pass the following four pieces of information for each web service to call coordinator component 402 for as many web service calls as desired. It should be noted that the order determined among the group numbers is guaranteed, e.g., these numbers are called in ascending order, and the service call order within the same group number is sorted by the call coordinator component 402. It should further be noted that web service calls can be written to a flat file.
1) The identification number of the web service (which can be arbitrarily numbered on the client side);
2) The group number of the web service;
3) The call HTTP method name and endpoint definition of the web service; and
4) The command (method name+URL) for calling the web service.
   Since 1) is ordered and returned from the call coordinator component 402, web services can be sequentially called in that order. If an error occurs in the middle, all the processes that have been executed to that point can be canceled and the lock can be released. If an error has not occurred, then all the processes are confirmed and the lock is released. It should be noted that the call coordinator component 402 can write the results out to a flat file for storage or archiving.

In one aspect of an embodiment of the present invention, call coordinator component 402 can read a list received from client applications and sort the list into a unified order. Call coordinator component 402 can request the host name aggregator component 404 (described subsequently) and the service name aggregator component 406 (described subsequently) for the host representative name and API endpoint representative name (full path), respectively, and normalize the character string, item “4)” as described above. In another aspect of an embodiment, call coordinator component 402 can sort the list for each group number in item “2)” as described above, based on the definition of the sort order defined according to the sorting rules (described subsequently), and the ordered list of web service identification numbers is returned to the client applications. For sorting by path parameters or query parameters, which part is the parameter can be identified by referring to item “3)” as described above.

For example, for the Hypertext Transfer Protocol (HTTP) method and Uniform Resource Locator (URL) structure of the command “PUT https://api.server1.org/v1/users/{user-id}?override={override},” the HTTP method is “PUT,” the host name is “api.server1.org,” the path parameter is “{user-id}?override,” the query parameter is “{override},” the API endpoint name (URL path part) is “v1/users/{user-id}?override” and the API endpoint name (full path) is “https://api.server1.org/v1/users/{user-id}?override.”

In another aspect of an embodiment of the present invention, host name aggregator component 404 can provide name identification of host names. Host name aggregator component 404 can receive a host name from call coordinator component 402 and return a name-identified representative name. It should be noted that if the representative name is not registered, the original host name is returned. For example, a host name identification can comprise the host name “server1,” the host DNS recognized name “server1-alias.net” and the internet protocol (IP) address “192.168.10.101.” In an environment where DNS can be used, a name identification function for simple conversion of host names and IP addresses is provided, and name identification can be achieved without setting a predefined rule for name identification. It should be noted that host name aggregator component 404 can write the results out to a flat file for storage or archiving.

In another aspect of an embodiment of the present invention, service name aggregator component 406 can provide name identification for each HTTP method of an API endpoint, e.g., full path. Service name aggregator component 406 can receives an API endpoint from call coordinator component 402 and return a name-identified representative name. It should be noted that if the representative name is not registered, the original API endpoint is returned. For example, for the command “PATCH https://server1/v1/customers/{customer-id}” service name aggregator component 406 can reply with “https://server1/v2/customers/{customer-id}” or considering another example, for the command “POST https://server2/v1/customers/{customer-id}/reservation-log” service name aggregator component 406 can reply with https://server2/v1/customers/{customer-id}/reserve. It should be noted that service name aggregator component 406 can write the results out to a flat file for storage or archiving.

In another aspect of an embodiment of the present invention, sorting rules component 408 can provide definition information defining the rules for web service call ordering. A sort order selection can be made, and the descending/ascending order can be selected for the following five elements. It should be noted that individual rules can also be applied on a per element basis. FIG. 7 is an example of definition information written to a flat file.

1) (Standardized) host name;

2) (Standardized) API endpoint name (URL path part);

3) HTTP method;

4) Path parameters that appear in the API endpoint name; and

5) Query parameters.

For example, sorting rules component 408 can define a call order rule as follows:
#sort order
sort_order=“host endpoint HTTP_method path_param_query_param”
#Host name is serverX, serverY comes at the top in the described order, the rest is sorted into #the ASCII ascending order.
host=“serverX serverY ASC”
#API endpoint names (URL path parts) are sorted into the ASCII ascending order.
endpoint=ASC
#HTTP method names are sorted in the described order.

### HTTP_method=“GET PUT PATCH POST DELETE”

#Path parameters are sorted in the order of appearance, into the ASCII ascending order.
path_param=“forward ASC”
#Query parameters are sorted in the order of appearance, into the ASCII ascending order.
query_param=“forward ASC”

In another aspect of an embodiment of the present invention, analytic component 410 can provide a mechanism for evaluating and improving the results of the case where the client applications have called a service in the execution order determined by call coordinator component 402. If an error occurs in a service call, analytic component 410 can provide call information on the location where the error occurred. In another aspect of an embodiment, analytic component 410 can receive details of the error from the client applications, collecting the error information to specify the call pattern in which errors occur frequently. Accordingly, analytic component 410 can create an execution order correction plan, resulting in dynamically updated sorting rules. It should be noted that collecting the error information can be based on analyzing nearby logs associated with the services.

In another aspect of an embodiment, analytic component 410 can for example with respect to situations where an estimated accuracy, e.g., confidence level, exceeds a predetermined threshold value, the host name identification definition file, the service name identification definition file, or the execution order control file can be added to allow the execution order to be changed dynamically without human intervention. Accordingly, if the error frequency of the same pattern increases, the change can be undone, and if the error frequency of the same pattern decreases, the change can be confirmed. For the situations wherein the estimated accuracy does not exceed a predetermined threshold value, the situation can be presented to an administrator as candidates for execution order correction, allowing the name identification definition file and execution order control file to be changed after administrator intervention.

FIG. 5 is an exemplary flowchart of a method 500 for preventing deadlocks when calling a plurality of web services in a single transaction. At step 502, an embodiment can receive, via call coordinator component 402, a list of service definitions from a client to call as one unit of work. At step 504, the embodiment can sort, via sorting rules component 408, host name aggregator component 404 and service name aggregator component 406, based on operations comprising applying a predetermined ordering rule, the list into a standardized order list. At step 506, the embodiment can send, via analytic component 410, the standardized order list to the client for execution by the client.

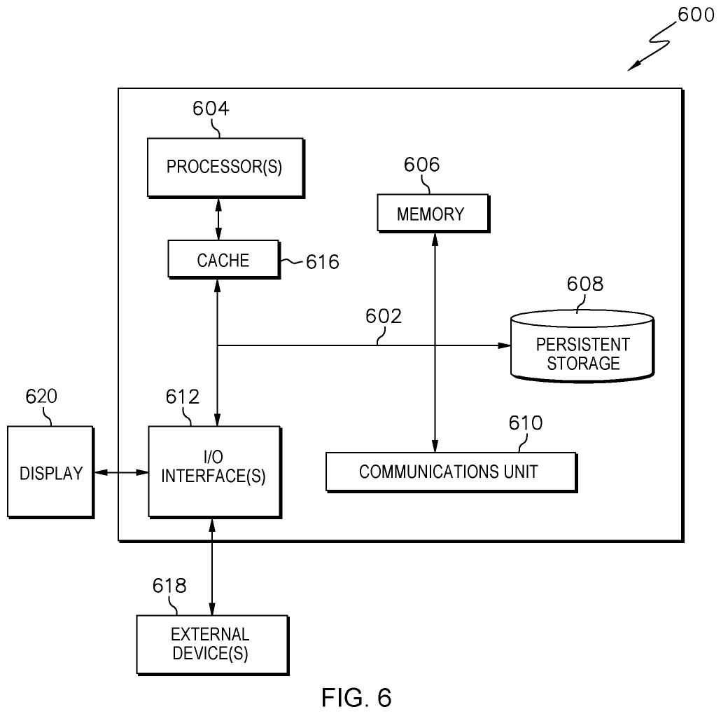

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O inter-face(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for preventing deadlocks when calling a plurality of web services in a single transaction, the computer-implemented method comprising:
receiving, by one or more processors, a list of service definitions from a client to call as one unit of work (UOW);
sorting, by the one or more processors, the list into a standardized order list based on operations comprising applying predetermined sorting rules; and
sending, by the one or more processors, the standardized order list to the client for client execution.

2. The computer-implemented method of claim 1, wherein the operations further comprise:
receiving, by the one or more processors, a plurality of host names;
normalizing, by the one or more processors, the plurality of host names;
creating, by the one or more processors, an aggregated list of host names based on the plurality of host names; and
including, by the one or more processors, the aggregated list of host names in the sorting.

3. The computer-implemented method of claim 2, further comprising:
receiving, by the one or more processors, a plurality of service endpoint names;
normalizing, by the one or more processors, the plurality of service endpoint names;
creating, by the one or more processors, an aggregated list of service endpoint names based on the plurality of service endpoint names; and
including, by the one or more processors, the aggregated list of service endpoint names in the sorting.

4. The computer-implemented method of claim 3, wherein one or more of the predetermined sorting rules, host names, and service endpoint names are written to a flat file to archive or reuse.

5. The computer-implemented method of claim 1, wherein the service definition comprises an identification number of a web service, a group number of the web service, a call Hypertext Transfer Protocol (HTTP) method name of the web service, an HTTP endpoint definition of the web service and a command associated with calling the web service.

6. The computer-implemented method of claim 5, wherein the command comprises a method name and a Uniform Resource Locator (URL) of the web service.

7. The computer-implemented method of claim 1, wherein the sorting is based on parameters comprising at least one of one or more standardized host names, one or more standardized application programming interface (API) endpoint names based on an associated URL path, one or more HTTP_method names, path parameters in an associated API endpoint name or query parameters.

8. A computer program product for preventing deadlocks when calling a plurality of web services in a single transaction, the computer program product comprising:
one or more non-transitory computer readable storage media and program instructions stored on the one or more non-transitory computer readable storage media, the program instructions comprising:
program instructions to receive a list of service definitions from a client to call as one unit of work (UOW);
program instructions to sort the list into a standardized order list based on operations comprising applying predetermined sorting rules; and
program instructions to send the standardized order list to the client for client execution.

9. The computer program product of claim 8, wherein the operations further comprise:
receiving, by the one or more processors, a plurality of host names;
normalizing, by the one or more processors, the plurality of host names;
creating, by the one or more processors, an aggregated list of host names based on the plurality of host names; and
including, by the one or more processors, the aggregated list of host names in the sorting.

10. The computer program product of claim 9, further comprising:
receiving, by the one or more processors, a plurality of service endpoint names;
normalizing, by the one or more processors, the plurality of service endpoint names;
creating, by the one or more processors, an aggregated list of service endpoint names based on the plurality of service endpoint names; and
including, by the one or more processors, the aggregated list of service endpoint names in the sorting.

11. The computer program product of claim 10, wherein one or more of the predetermined sorting rules, host names, and service endpoint names are written to a flat file to archive or reuse.

12. The computer program product of claim 8, wherein the service definition comprises an identification number of a web service, a group number of the web service, a call Hypertext Transfer Protocol (HTTP) method name of the web service, an HTTP endpoint definition of the web service and a command associated with calling the web service.

13. The computer program product of claim 12, wherein the command comprises a method name and a Uniform Resource Locator (URL) of the web service.

14. The computer program product of claim 8, wherein the sorting is based on parameters comprising at least one of one or more standardized host names, one or more standardized application programming interface (API) endpoint names based on an associated URL path, one or more HTTP_method names, path parameters in an associated API endpoint name or query parameters.

15. A computer system for preventing deadlocks when calling a plurality of web services in a single transaction, the computer system comprising:
one or more computer processors;
one or more non-transitory computer readable storage media; and
program instructions stored on the one or more non-transitory computer readable storage media, the program instructions comprising:
program instructions to receive a list of service definitions from a client to call as one unit of work (UOW);
program instructions to sort the list into a standardized order list based on operations comprising applying predetermined sorting rules; and
program instructions to send the standardized order list to the client for client execution.

16. The computer system of claim 15, wherein the operations further comprise:
receiving, by the one or more processors, a plurality of host names;
normalizing, by the one or more processors, the plurality of host names;
creating, by the one or more processors, an aggregated list of host names based on the plurality of host names; and
including, by the one or more processors, the aggregated list of host names in the sorting.

17. The computer system of claim 16, further comprising:
receiving, by the one or more processors, a plurality of service endpoint names;
normalizing, by the one or more processors, the plurality of service endpoint names;
creating, by the one or more processors, an aggregated list of service endpoint names based on the plurality of service endpoint names; and
including, by the one or more processors, the aggregated list of service endpoint names in the sorting.

18. The computer system of claim 17, wherein one or more of the predetermined sorting rules, host names, and service endpoint names are written to a flat file to archive or reuse.

19. The computer system of claim 15, wherein the service definition comprises an identification number of a web service, a group number of the web service, a call Hypertext Transfer Protocol (HTTP) method name of the web service, an HTTP endpoint definition of the web service and a command associated with calling the web service, wherein the command comprises.0 a method name and a Uniform Resource Locator (URL) of the web service.

20. The computer system of claim 15, wherein the sorting is based on parameters comprising at least one of one or more standardized host names, one or more standardized application programming interface (API) endpoint names based on an associated URL path, one or more HTTP_method names, path parameters in an associated API endpoint name or query parameters.
